(19) United States
(12) Patent Application Publication
(10) Pub. No.: US 2012/0227917 A1
(43) Pub. Date: Sep. 13, 2012

(54) HOLLOW SLAT

(75) Inventors: WEN-YING LIANG, Changhua County (TW); Sheng Ying Hsu, Changhua County (TW)

(73) Assignee: CHING FENG HOME FASHIONS CO., LTD., CHANGHUA COUNTY (TW)

(21) Appl. No.: 13/042,277

(22) Filed: Mar. 7, 2011

(51) Int. Cl. E06B 9/386

(52) U.S. Cl. 160/236

(57) ABSTRACT

A hollow slat includes an elongate body having a space defined therein and two ends of the elongate body are two closed ends. At least two through holes are defined through top and bottom surfaces of the elongate body and each through hole has a peripheral wall which is connected between the top and bottom surfaces of the elongate body such that the through holes are not in communication with the space in the elongate body.

### FIELD OF THE INVENTION

The present invention relates to a slat, and more particularly, to a hollow slat for blinds and the slat having two closed ends and the through holes for control ropes are isolated from the interior space of the hollow slat.

### BACKGROUND OF THE INVENTION

A conventional slat for blinds is a solid slat which is heavy and costly. The thickness of the slat is difficult to be properly determined when the material of the slat is also heavy. The thickness affects the visual appearance, the manufacturers want the slats to be thin enough while the structural strength is maintained. A hollow salt is then developed.

The conventional hollow slats known to applicant are disclosed in U.S. Pub. No. 2007/0151678, 2007/02779440 and 2006/0060311. The conventional hollow slats each include multiple ribs which are connected between the two surfaces of the hollow slat to maintain proper strength of the slat. However, some of the conventional hollow slat includes two open ends which may introduce the dust into the interior space in the hollow slat. The dust will stick on the inside of the hollow slat and is difficult to be cleaned. Some of the conventional slots have closed ends which require complicated machining processes and the through holes for control ropes are still in communication with the interior space in the hollow slats.

The present invention intends to provide a hollow slat which has closed ends on two ends thereof and the through holes for the control ropes are also sealed so that not dust can enter into the interior space of the slat.

### SUMMARY OF THE INVENTION

The present invention relates to a hollow slat and comprises an elongate body which has a space defined therein and two ends of the elongate body are two closed ends. At least two through holes are defined through top and bottom surfaces of the elongate body and each through hole has a peripheral wall which is connected between the top and bottom surfaces of the elongate body, so that the through holes are not in communication with the space in the elongate body.

Preferably, two respective distal ends of the top surface and the bottom surface of each of the two ends of the elongate body are connected to each other and form a protrusion extending longitudinally from each of the two ends of the elongate body.

Preferably, two respective distal ends of the top surface and the bottom surface of each of the two ends of the elongate body are connected to each other and form a rounded end.

The primary object of the present invention is to provide a hollow slat which has two closed ends and the through holes for the control ropes are also sealed so that the interior space is not in communication with outside.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the hollow slat of the present invention;

FIG. 2 is a perspective view to show the untreated piece of the hollow slat of the present invention;

FIG. 3 is an exploded view to show the untreated piece of the hollow slat of the present invention, the mold set and the blade mold;

FIG. 4 is a cross sectional view, taken along line 4-4 in FIG. 1;

FIG. 5A is a cross sectional view of the first embodiment of the closed end of the hollow slat of the present invention;

FIG. 5B is a cross sectional view of the second embodiment of the closed end of the hollow slat of the present invention, and

FIG. 6 is a cross sectional view, taken along line 6-6 in FIG. 1.

### DETAILED DESCRIPTION OF THE PREFERRED EMBODIMENT

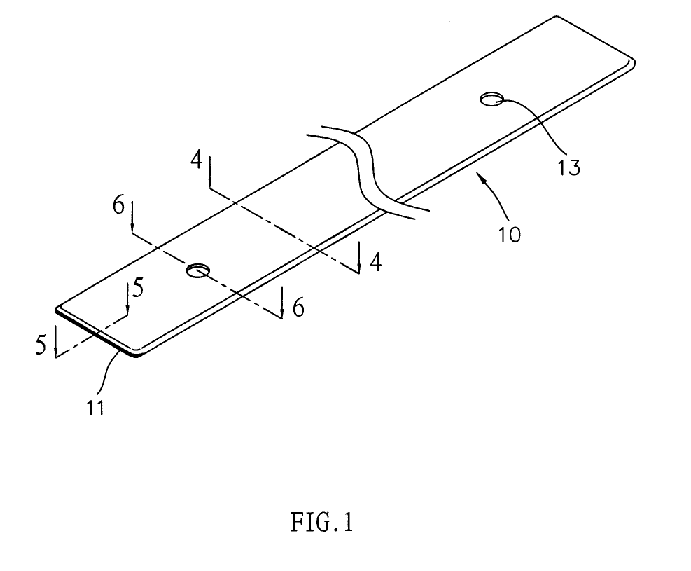

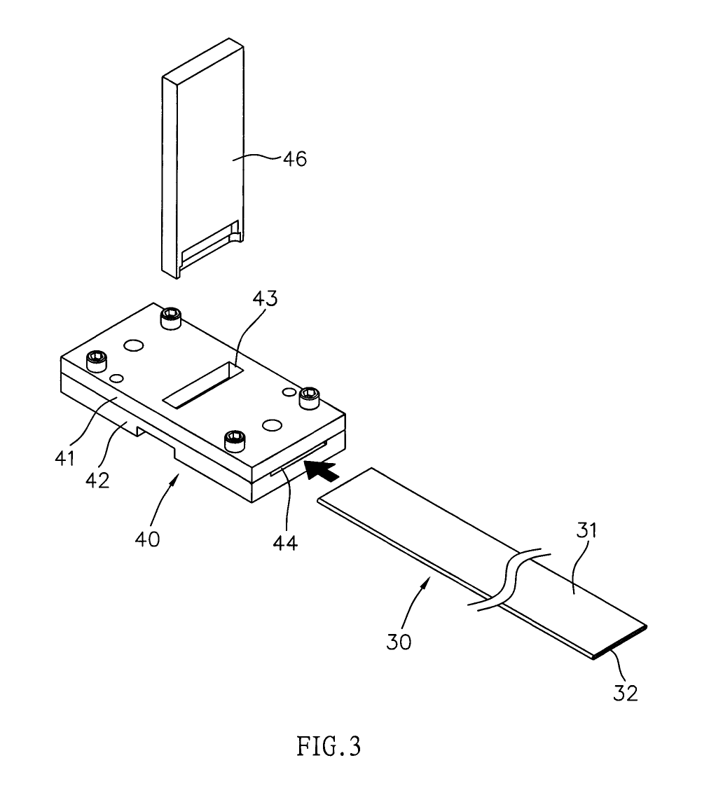

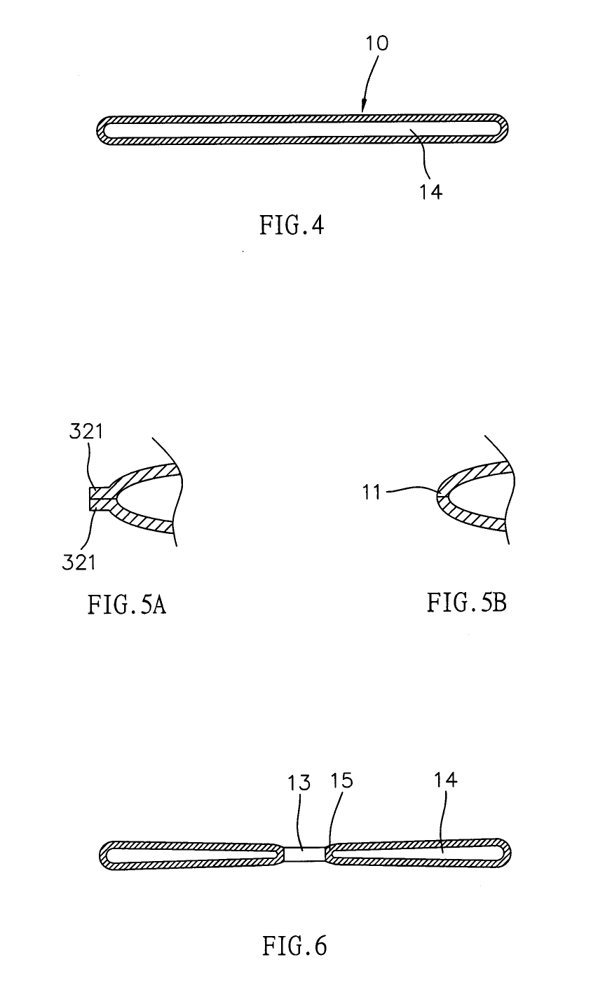

Referring to FIGS. 1 and 4, the hollow slat 10 of the present invention comprises an elongate body having a space 14 defined therein and two ends of the elongate body are two closed ends 11. Two through holes 13 are defined through top and bottom surfaces of the elongate body and each through hole 13 has a peripheral wall 15 which is connected between the top and bottom surfaces of the elongate body, such that the through holes 13 are not in communication with the space 14 in the elongate body. The two through holes 13 are for control ropes of blind (not shown) passing therethrough.

As shown in FIGS. 4, 5A and 6, the two respective distal ends 321, 321 of the top surface and the bottom surface of each of the two ends of the elongate body are connected to each other. The underside of the distal end of the top surface is directly connected to a top of the distal end of the bottom surface so as to form a protrusion extending longitudinally from each of the two ends of the elongate body. The two respective protrusions extend in opposite directions on the two closed ends of the hollow slat 10 and are easily to be machined.

As shown in FIG. 5B, another embodiment of the closed ends 11 is that the two respective distal ends of the top surface and the bottom surface of each of the two ends of the elongate body are connected to each other. The end surface of the distal end of the top surface is bent and directly connected to the end surface of the distal end of the bottom surface so as to form a rounded end. The rounded ends have smooth outer appearance and meet aesthetic requirements.

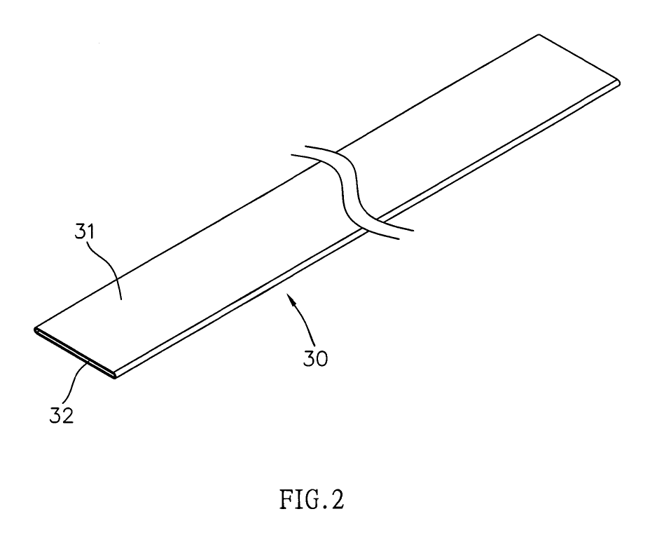

As shown in FIGS. 2 and 3, the hollow slat 10 is made from the untreated piece 30 which is an elongate body 31 and includes two opened ends 32. A mold set 40 includes a top mold 41 and a bottom mold 42, the mold set 40 includes an inlet 44 defined in one end thereof. A tool entrance 43 is defined in the top mold 41. A tool 46 which includes a function end with specific shape and the tool 46 is inserted into the tool entrance 43 when the untreated piece 30 is inserted into the inlet 44. The tool 46 cuts the untreated piece 30, forms the end of the untreated piece 30, and treating the pressing and/or heat fusion process to the open end 32 of the untreated piece 30 to form the closed end 11. The closed ends as shown in FIGS. 5A and 5B are easily made by using the mold set 40 and the tool 46.

The through holes 32 are made by the mold set 40 and by using the tool 46 which makes the through holes 32 and seals the through holes 32 by forming the peripheral wall 15.

The hollow slat 10 of the present invention prevents dust from entering the interior space 14 by having the two closed ends 11 and the peripheral sealed through holes 13 so that the shortcomings of the conventional hollow slats are improved.

While we have shown and described the embodiment in accordance with the present invention, it should be clear to those skilled in the art that further embodiments may be made without departing from the scope of the present invention.

What is claimed is:

1. A hollow slat comprising:
an elongate body having a space defined therein and two ends of the elongate body being two closed ends, at least two through holes defined through top and bottom surfaces of the elongate body and each through hole having a peripheral wall which is connected between the top and bottom surfaces of the elongate body, the through holes being not in communication with the space in the elongate body.

2. The hollow slat as claimed in claim 1, wherein two respective distal ends of the top surface and the bottom surface of each of the two ends of the elongate body are connected to each other, an underside of the distal end of the top surface is directly connected to a top of the distal end of the bottom surface so as to form a protrusion extending longitudinally from each of the two ends of the elongate body.

3. The hollow slat as claimed in claim 1, wherein two respective distal ends of the top surface and the bottom surface of each of the two ends of the elongate body are connected to each other, an end surface of the distal end of the top surface is bent and directly connected to an end surface of the distal end of the bottom surface so as to form a rounded end.
